(19) United States
(12) Patent Application Publication
(10) Pub. No.: US 2015/0127302 A1
(43) Pub. Date: May 7, 2015

(54) METHOD AND APPARATUS FOR OPTIMIZED ROUTING

(71) Applicant: Jeffrey Odell Johnson, Las Cruces, NM (US)

(72) Inventor: Jeffrey Odell Johnson, Las Cruces, NM (US)

(73) Assignee: The Government of the United States as Represented by the Secretary of the Army, Adelphi, MD (US)

(21) Appl. No.: 14/073,908

(22) Filed: Nov. 7, 2013

(51) Int. Cl. G06F 17/50

(52) U.S. Cl. CPC G06F 17/50
USPC 703/1

(57) ABSTRACT

A method and apparatus for path optimization comprising receiving model data, obstacle data and impact data describing an environment, parsing the model and obstacle data and constructing a three-dimensional data grid and calculating the cost of a path traversal from a start node to an end node based on cost of movement and the impact data.

### GOVERNMENT INTEREST

Governmental Interest—The invention described herein may be manufactured, used and licensed by or for the United States Government.

### FIELD OF USE

Embodiments of the present invention generally relate to obstacle avoidance and, more particularly, to a method and apparatus for optimized air and land physical path selection.

### BACKGROUND

Path optimization refers to the process of optimizing a path from an initial point to a target point in a particular grid space. Known applications for solving path optimization problems have been implemented for two-dimensional space, however these applications are not flexible with respect to data input types, and are limited to pre-defined networks for the routing solution. Solutions to path optimization problems also generally execute inefficiently, or have some combination of one or more of the above limitations. Other solutions for path optimizations have taken into account weather avoidance as a part of obstacle avoidance, but provide no flexibility with respect to other environmental or external impacts that may affect path resolution.

Therefore there is a need in the art for implementing an efficient and flexible path optimization solution suitable for dynamic routing solutions.

### SUMMARY

Embodiments of the present invention relate to a method and apparatus for path optimization comprising receiving model data, obstacle data and impact data describing an environment, parsing the model and obstacle data, constructing a three-dimensional data grid from the parsed model and obstacle data, and calculating the cost of a path (over space and time) traversal from a start node to an end node based on the impact data and user-requested constraints.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a path optimization apparatus in accordance with exemplary embodiments of the present invention;

FIG. 2 is a depiction of grid cells contained within the data grid created by the model importer in accordance with exemplary embodiments of the present invention;

FIG. 3 is a detailed illustration of the path optimizer in accordance with exemplary embodiments of the present invention;

FIG. 4 is a depiction of the path optimization with reference to a set of grid cells in accordance with exemplary embodiments of the present invention;

FIG. 5 is a block diagram of a computer system for implementing the path optimization apparatus in accordance with exemplary embodiments of the present invention; and

FIG. 6 is a depiction of a flow diagram for a method 600 for path optimization in accordance with exemplary embodiments of the present invention.

### DETAILED DESCRIPTION

Embodiments of the present invention relate to path optimization from a starting node to an ending node which correspond to physical start points and end points in a physical environment such as airspace, terrain, or an urban area. The present invention makes use of impact values and obstacles to determine the best path to take from the start point to the end point, considering all factors. The invention gives optimized paths in 3D space over a period of time as the environment changes and is flexible so as to allow for dynamic routing based on these changes. The path optimization can be used to optimize paths through adverse weather conditions by aircrafts, through radiation hazards, complex terrain navigation by vehicle or foot, chemical and bio-hazardous area traversal, dust plume traversal, ocean surface travel or underwater travel avoiding strong currents and traversing areas with varying threat levels in ground, air or sea.

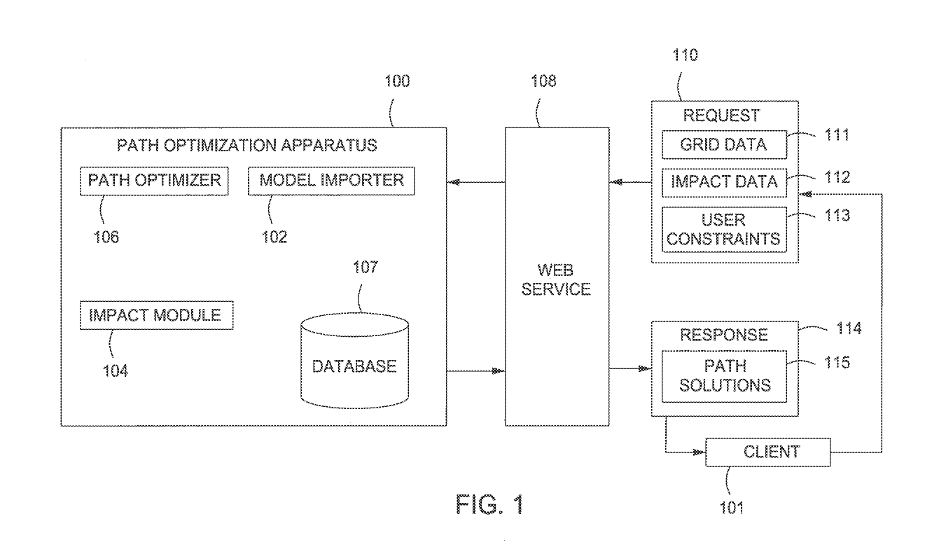

FIG. 1 depicts a path optimization apparatus 100 in accordance with exemplary embodiments of the present invention. The apparatus 100 comprises a model importer 102, an impact module 104, a path optimizer 106 and a database 107. According to exemplary embodiments of the present invention, the model importer 102, impact module 104, path optimizer 106 and database 107 may be collocated, or in other embodiments may be located remotely from each other and communicate over a wired or wireless network.

The path optimization apparatus 100 is exposed to a wider network through a web service 108. The web service 108 may be provided via a Java based web-service provider or any web service provider known to those of ordinary skill in the art. The web service 108 provides access between the path optimization apparatus 100 and client 101. Client 101 requires real-time knowledge of how to traverse a particular area in a physical environment (i.e., of real-space, e.g., a city block). Three-dimensional model data is available to the client 101 a priori through geo-spatial databases or the like. In addition, obstacle data is either observed, identified and modeled in three-dimensions (3D) or provided to the client 101 in a 3D format. The client 101 then generates a request 110 to the web service 108 to retrieve an ideal path to take from a starting point and an ending point, the starting and ending points specified by the client 101. Multiple clients may simultaneously access the web service 108 to request an ideal path according to this embodiment.

The request 110 comprises grid data 111, which comprises at least the model data and the obstacle data described above, impact data 112 and user constraints 113. Impact data 112 consists of impact values for each individual grid unit in the 3D model of the real-space environment and the obstacles in the real-space environment. An impact value represents the level of adverse conditions in a particular location in the real-space environments. The impact value may represent a threat level, dust concentration, chemical concentration, water currents, weather conditions, radiation levels, terrain slopes and types, or the like. The impact value may be an integer value or a floating point value, where a lower value represents low adverse conditions and high values represent high levels adverse condition. Any high impact value area would be an area that the ultimate optimized path should avoid. According to some embodiments, the impact values may be from 0 to 2. In other embodiments, the impact values range from 0-30, but may differ depending on the granularity and resolution required in a particular real-space environment,

Impact values are generally identified as being a specific value for obstacle locations in three-dimensional space. For example, an obstacle impact value may be 100 to represent that this is a high adversity location and therefore should be avoided in an optimized path. In other instances, an obstacle impact value may be set to “−99” so that the optimized path avoids any calculations on the obstacle location altogether.

The request 110 is relayed to the web service 108 through a wired or wireless network. The web service 108 forwards the request 110 to the path optimization apparatus 100. The path optimization apparatus 100 dispatches the model importer 102 to receive and parse all 3D model data. The model data may be model data of a city, terrain, an interior space, or the like. Those of ordinary skill in the art would recognize that 2D representations of real space may also be used and the model importer 102 is also capable of parsing 2D representational data. In some instances, the model importer 102 expects data in a textual representation such as a comma separated value (CSV) file. In other instances, the model and impact may be in the form of an extensible markup language (XML) file delineating each 3D coordinate and its associated impact value. Obstacle data may also be presented in an XML, CSV, or any other appropriate format which indicates where an obstacle is located in 3D space, relative to the rest of the terrain.

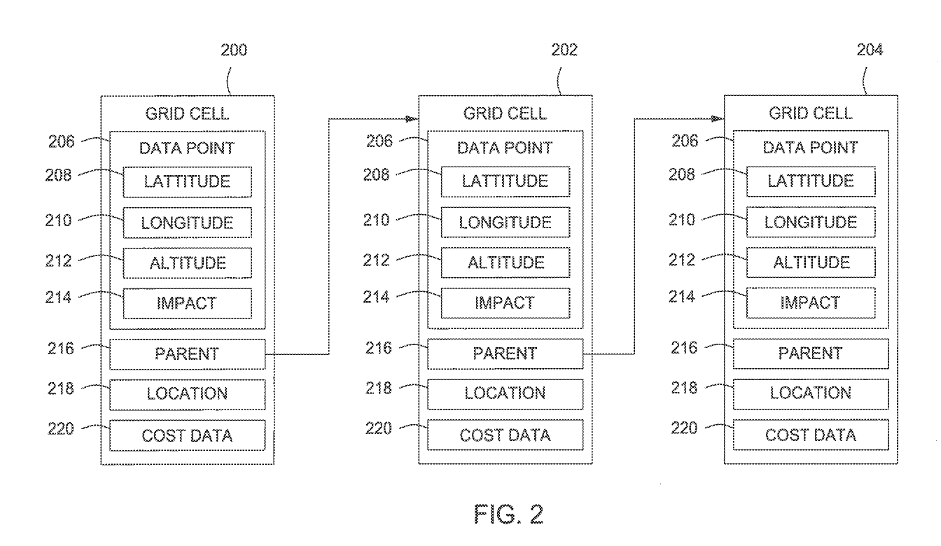

The model importer 102 generates a grid cell for each coordinate in the model data according to a user specified resolution of the virtual representation of the environment. For example, in some instances a user may not need in-depth information about path traversal, and therefore for every 10×10×10 coordinates of the 3D data, one grid cell will be generated. In other instances, other resolutions such as 1×1×1 coordinates for every grid cell may be implemented. The plurality of grid cells generated by the model importer 102 represent a data grid, a virtual representation of the model including obstacle data. The data grid is formed by a parent-child structure, discussed in relation to FIG. 2 below. The data grid is stored in database 107 for future use. According to some embodiments, the client 101 may send multiple requests with grid data 111 that differs over time, and the model importer augments the data grid as the new requests are periodically received.

Once the model importer 102 parses the model, obstacle and impact data 112 and the user constraints 113, and generates the data grid of the air/terrain and obstacles in the air/terrain, the impact module 104 associates each coordinate in the virtual representation with an impact value for the associated grid cell, if one has been supplied for that particular coordinate. In some embodiments, if an impact value has not been supplied for a particular coordinate, an impact value is associated with that coordinate based on the impact value supplied for a neighboring coordinate.

The path optimizer 106 then generates an optimized path from the user specified start point to the user specified end point based on path optimization algorithms, as described below.

FIG. 2 is a depiction of grid cells contained within the data grid created by the model importer 102 in accordance with exemplary embodiments of the present invention. Grid Cells are objects which contain state information about themselves. In short, when a “path” is finally determined, there is no “line” defined. Instead, each grid cell has information about its state, and also what its Parent node is. Thus, from any grid cell, a complete path back to the “start” point can be identified from the algorithm. In this case of an optimized path in this implementation, the grid cell which is at the “end” point and results in the least cost for a path from the start point to the end point is identified.

For example, FIG. 2 depicts three grid-cells 200, 202 and 204. The path optimizer 106 may, according to an exemplary embodiment, return grid cell 200 as a result of path optimizing a particular terrain and set of obstacles associated with impact data. The grid-cell 200 contains a data point 206. The data point 206 represents a 2D or 3D point in space that corresponds to a relative point in space of the physical terrain which was imported by the model importer 102. The data point 206 may also represent a point in space corresponding to the physical point in space of an obstacle imported by model importer 102. The data point 206 further comprises latitude 208, longitude 210, altitude 212 and impact value 214. The latitude 208, longitude 210 and altitude 212 represent coordinates in the three dimensions of the data point 206 in space and the impact value 214 is assigned based on the impact data 112, corresponded to the data point 206 by the impact module 104.

According to some embodiments, the impact value 214 for this data point is an integer, but may be a floating point value, or any other appropriate type. In this embodiment, the integers range used is 0, 1 and 2 for low, medium and high impact values, respectively. For example, a “low” impact can be an area with limited adverse conditions (for any data type), and “high” would indicate a high level of adverse conditions, and something the resulting path calculation described here would avoid, if at all possible. Though values of 0, 1 and 2 are expected, values may have any predetermined range, such as from 0-30, and apparatus 100 may handle any impact values imported by the model importer 102 and will scale accordingly. In addition to the impact values, a “value” for an obstacle can be evaluated. A value of −99 is used to identify an obstacle to be avoided. In the solution, any grid cell which is marked with −99 will not be considered in the path returned by the path optimizer 106, which is different than a grid cell with even a very large impact value, which will still be considered.

The grid cell 200 further comprises parent reference 216, location 218 and cost data 220. The location 218 indicates the location of the grid cell in 3D virtual space occupied by the data grid based on the latitude 208, longitude 210 and altitude 212. The cost data 220 may comprise several cost variables. According to one embodiment, the cost data 220 comprises at least an impact cost. The impact cost at this grid cell 200 is similar to the impact value 214; however, the impact cost can be a weighted value for adjustments to an optimized path solution. For example, the weighting of impact cost may be weighted to avoid any impacts by scaling up the impact cost as compared with the impact value 214. The result is a lower-risk, but possibly longer path (spatially and temporally).

The cost data 220 may also further comprise a local move cost. The local move cost indicates the cost of movement from the parent cell, indicated by parent reference 216, to this grid cell 200. The cost data 220 may further comprise a gCost, an hCost and an fCost. The gCost indicates a distance cost plus the impact cost from a start point to the current point, The hCost represents a Heuristic function, which is an optimistic (least-cost) estimate from a current grid cell to a goal node (i.e., the end point). According to this embodiment, the hCost assumes that there are zero impacts from the current position to the goal node, as that is the minimum case (and there is no way to determine otherwise, as they are effectively random values). Thus, the optimistic estimated cost would only include the estimated movement costs to the goal node from the current node. The fCost represents the total cost at this grid cell 200, where fCost=gCost+hCost. According to one embodiment of the present invention, the movement cost of moving to a node n in the data grid can be represented by the following formula:

f(n)=g′(n)+h(n)

Here, f(n) represents the movement cost from a current node to the node “n”. The value g′(n) represents the cost along the current path to the node n from the start grid cell, plus the impact cost (i.e., the impact value associated with the current grid cell) of the node n. Finally, h(n), as described above represents the heuristic function, which is an estimate of the least-cost path remaining between the node n and the end grid cell.

As shown in FIG. 2, the grid cell 200 contains a parent reference 216. The parent reference 216 points to a parent grid cell, e.g., grid cell 202. This indicates that the parent of grid cell 200 is grid cell 202. Similarly, the parent of grid cell 202 is grid cell 204. The parent reference is assigned by the path optimizer 106 as the path optimizer inspects each grid cell contained in the data grid generated by the model importer 102. If the path optimizer 106, for example, begins at grid cell 204 and determines that the least cost next path would be to move to grid cell 202, the parent reference of grid cell 202 will be assigned to reference grid cell 204. Similarly, the path optimizer 106 then determines what the next least cost path move would be, and if the next least cost path is determined to be to move to grid cell 200, the parent reference 216 of grid cell 200 is assigned to reference grid cell 202. Finally, once the path optimizer 106 has completed its solution to the end node indicated by client 101, grid cell 200 is returned, containing references to each parent tracing back to the start node indicated by the client 101.

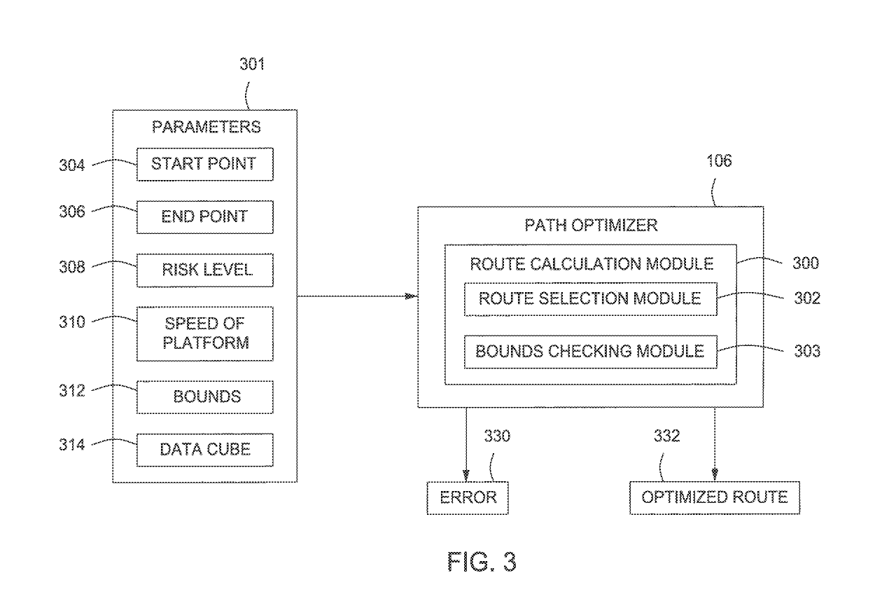

FIG. 3 is a detailed illustration of the path optimizer 106 in accordance with exemplary embodiments of the present invention. The path optimizer is provided with parameters 301 and determines an optimized route 332. The optimized route is embedded into path solutions 115 and returned to client 101 via response 114. If an error occurs during evaluation of the optimized route, errors 330 are also returned to the client 101 via the response 114. The path optimizer 106 may compute several path solutions/optimized routes if the grid data 111 or the impact data 112 from FIG. 1 is periodically updated.

The parameters 301 comprise a start point 304, an end point 306, a risk level 308, a platform speed 310, bounds 312 and a data cube 314. The start point 304 indicates where a user of client 101 would like to begin the optimized path and the end point 306 determines the ultimate “goal” of the optimized path. In some embodiments, the goal may be referred to as a goal node, or goal grid cell. The start point 304 and end point 306 are either 2D points for a 2D model or 3D points for a 3D model. The risk level 308 is a risk level of the optimized route being returned. For example, a user may accept higher risk to arrive to the goal node in a shorter period of time or shorter distance. According to one embodiment, a “higher risk” solution may be returned, and the optimized route is returned in the response or as local output data. The risk level 308 may be in the range of 0-1. The bounds 312 indicate vertical boundaries that the path optimizer 106 should stay within and is an optional parameter. For example, in some embodiments, individual grid cell impacts are used to indicate boundaries instead of the bounds 312 parameter. The data cube 314 is a collection of the plurality of grid cells representing the model and obstacles modeled in 3D space by the model importer 102. Each grid cell in the data cube 314 contains the data shown in FIG. 2, grid cell 200,

The path optimizer 106 further comprises a route calculation module 300. The route calculation module 300 comprises a route selection module 302 and a bounds checking module 303. The route calculation module 300 converts the start point 304 and end points 306 from longitude, latitude and altitude values to (x, y, z) positions for 3D path optimization and (x, y) positions for 2D path optimization. The bounds checking module 303 determines whether the start point 304 and end point 306 are located within an obstacle, or outside of the bounds parameter 312. If the start point 304 or end point 306 is located within an obstacle or outside the bounds 312, an error 330 is output by the path optimizer 106. The bounds checking module 303 performs a vertical boundary check if required.

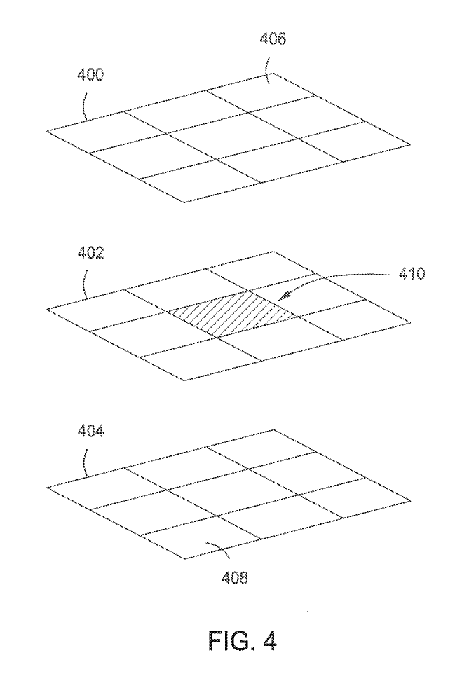

With reference to FIG. 4, according to an exemplary embodiment of the present invention, the start cell is determined to be grid cell 410. Adjacent grid cells are then examined, Le., all cells within grid layer 400, 402 and 404, that are adjacent the starting grid cell 410. Therefore, 26 adjacent grid cells are examined and added to an open list once the cost to move to each of those cells is determined. For example, as the grid cells surrounding grid cell 410 are visited or “expanded”, each grid cell is added to the “open list”, containing all possible grid cells one can move to. The route selection module 302 determines whether a particular grid cell is associated with an obstacle, i.e., the impact value of the grid cell is set to “−99”, where “−99” has been preconfigured to represent obstacles by an administrator of path optimization apparatus 100, or provided in the request 110 by the client 101. The bounds checking module 303 determines whether the grid cells are within bounds 312.

The route selection module 302 cycles through adjacent cells, starting with upper left grid cell 406, proceeding down each of the three columns, row by row to grid cell 408. Each cell is added to the “open list” (if not already there), excluding the “start” cell, which is an exception as described, below. The route selection module 302 determines whether the grid cells are not out of bounds in the x-y direction and then determines if this is the start cell or a new parent cell. In both cases, the grid cells are moved to the “closed list” since they have already been evaluated.

The calculated movements are as if moving through a cube, with the “current” (aka, parent cell) node being at the center of this cube. Each of the three layers of the cube contains 9 cells, for a total of 27 cells, which means 26 possible movement positions from the center/parent cell. If the grid cells are not the start cell or a parent cell, the grid cell is an adjacent cell. The route selection module 302 calculates a move time from the parent cell, distance traveled from the start grid cell 410, and arrival time to this particular grid cell. Subsequently, the route selection module 302 determines this particular grid cell's relative position to the start grid cell 410. The route selection module 302 then determines the local move cost to the current grid cell based on its relative position to the new parent cells. The local move cost is determined based on these relative positions, as well as the relative vertical position of the current grid cell from the current new parent cell. If the current grid cell has been visited before as an expanded node, it already has a “total cost” associated with it, so here it is referred to as an “original total cost.” The route selection module 302 determines whether the new parent cell is a better parent than the current parent by determining whether the total cost to the current grid cell is a lower cost than its original total cost.

If the route selection module 302 determines that the cost to the current grid cell is a lower cost than the original total cost, the parent of the current grid cell is assigned as the new parent cell. The total cost and move cost are adjusted accordingly, while the heuristic cost remains unchanged since the estimate from the current grid cell to the end point 306 is unchanged. In short, finding a “better parent” means a better (lower cost) path has been found, and so the algorithm makes the proper adjustments to keep the better path.

Subsequently, the route selection module 302 adds the grid cells above and below the start grid cell 410 to determine their cost. The “open list” is then sorted by the route selection module 302, leaving the lowest cost grid cell at the top of open list. Once the grid cell being examined is determined to encompass the end point 306, the route selection module 302 completes the analysis. The grid cell being examined when the analysis is complete contains parent references that trace back to a grid cell encompassing the start point 304, namely grid cell 410. This list of grid cells references is returned as the optimized route 332. According to some embodiments, the optimized route 332 may be converted into various formats such as XML, Keyhole Markup Language (KML) or similar data formats. The optimized route 332 may comprise several routes, varying over time as the data grid is updated or augmented with additional data.

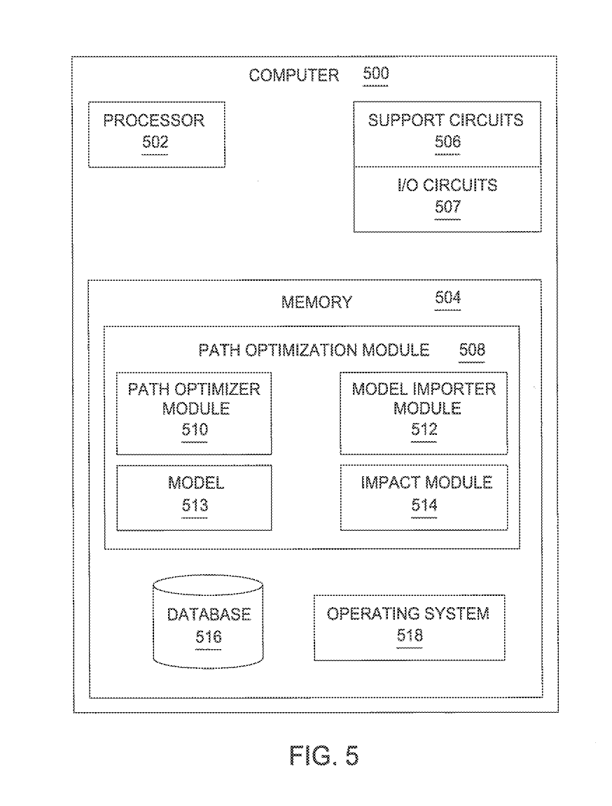

FIG. 5 is a block diagram of a computer system 500 for implementing the path optimization apparatus 100 in accordance with exemplary embodiments of the present invention. The computer 500 comprises a processor 502, various support circuits 506, and memory 504. The processor 502 may include one or more microprocessors known in the art. The support circuits 506 for the processor 502 include conventional cache, power supplies, clock circuits, data registers, I/O circuits 507, and the like. The I/O circuits 507 may be directly coupled to the memory 504 or coupled through the support circuits 506. The I/O circuits 507 may also be configured for communication with input devices and/or output devices such as network devices, various storage devices, mouse, keyboard, display, video and audio sensors, RF receivers and RF transmitters or the like.

The memory 504, or computer readable medium, stores non-transient processor-executable instructions and/or data that may be executed by and/or used by the processor 502. These processor-executable instructions may comprise firmware, software, and the like, or some combination thereof. Modules having processor-executable instructions that are stored in the memory 504 comprise a path optimization module 508 and a database 516.

As described below, in an exemplary embodiment, the path optimization module 508 comprises a path optimizer module 510, model importer module 512 and an impact module 514. The computer system 500 may be programmed with one or more operating systems 518, which may include OS/2, Java Virtual Machine, Linux, SOLARIS, UNIX, HPUX, AIX, WINDOWS, IOS, and ANDROID among other known platforms.

The memory 504 may include one or more of the following random access memory, read only memory, magneto-resistive read/write memory, optical read/write memory, cache memory, magnetic read/write memory, and the like, as well as signal-bearing media as described below.

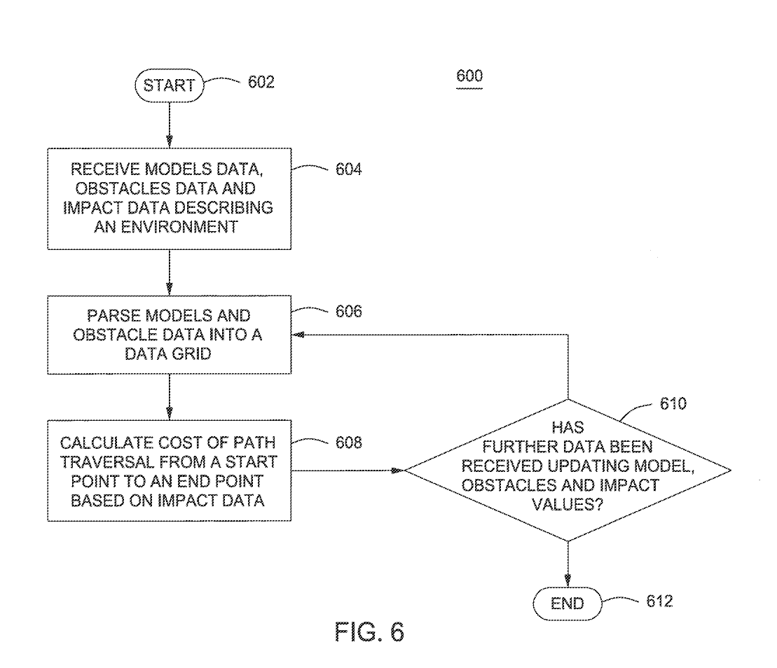

FIG. 6 is a depiction of a flow diagram for a method 600 for path optimization in accordance with exemplary embodiments of the present invention. The method 600 is an exemplary flow of the path optimization apparatus 100 implemented as the path optimization module 508, executed by the processor 502 on computer 500. The method begins at step 602 and proceeds to step 604.

At step 604, the path optimization module 508 receives model data, obstacle data and impact data describing a three-dimensional environment, obstacles within the 3D environment, and impact values for each point in that 3D environment.

The method proceeds to step 606 where the model data and obstacle data is parsed by the model importer module 512 and a 3D (or 2D depending on the input data) model 513 is generated and stored in memory 504.

At step 608, the path optimizer module 510 calculates the cost of path traversal from a start point to an end point based on the impact value data and obstacles within the data grid, as described with respect to FIGS. 3 and 4 above, According to some embodiments the path optimizer module 510 may use a modified A* algorithm to compute the path. In other embodiments, the D* algorithm may be used, or any suitable path optimization algorithm, modified with the use of impact and obstacle values structured as shown in the preceding Figures. At step 610, the path optimizer module 510 determines whether further data is received updating the model terrain, obstacles and impact values, and if updates are received, the method returns to step 606. Otherwise, the method terminates at step 612.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

Various elements, devices, modules and circuits are described above in associated with their respective functions. These elements, devices, modules and circuits are considered means for performing their respective functions as described herein. While the foregoing is directed to embodiments of the present invention, other and further embodiments of the invention may be devised without departing from the basic scope thereof, and the scope thereof is determined by the claims that follow.

1. A method for path optimization comprising:
receiving model data, obstacle data and impact data describing an environment;
parsing the model and obstacle data and constructing a multi-dimensional data grid from the model and obstacle data; and
calculating the cost of a path traversal from a start node to an end node in the multi-dimensional data grid based on the impact data.

2. The method of claim 1 further comprising:
wherein the received model data is data modeling a three-dimensional (3D) environment, the obstacle data is data modeling obstacles in the 3D environment, and the impact data is data describing impact relating to moving to a particular location the 3D environment.

3. The method of claim 2 further comprising:
augmenting, periodically, the model, obstacle and impact data over time as the 3D environment changes.

4. The method of claim 3 further comprising:
performing the calculating of cost of path traversal when the model, obstacle and impact data is augmented; and
providing a four dimensional optimized route based on the calculated cost of path traversal, wherein the optimized route is represented in three-dimensional space along a changing time dimension.

5. The method of claim 4 wherein calculating the cost of path traversal further comprises:
calculating a total cost at a grid cell from a plurality of grid cells comprising the data grid by summing g(n), a sum of costs along a path to a current node from the start node, an impact cost from the impact data correlated to the current node, and h(n), a heuristic function estimating a least cost path remaining between the current node and the end node, wherein each node besides the start and end node have a parent node referencing another grid cell.

6. The method of claim 5 further comprising:
performing the calculating a total cost from the start node to the end node, by:
selecting a grid cell as a parent cell and iterating over cells adjacent to the parent cell;
determine whether a current node, or grid cell, in the data grid is the start node or the parent cell;
calculating the cost of moving to each grid cell in the data grid, and moving that grid cell to a closed list if the cell is not the start node or the parent cell;
moving the current node to an open list if the cell is the start node or the parent cell;
determining a relative position between the current node and the parent cell;
determining a local cost of moving to the current node based on the determined relative position;
determining whether the current node is a better node than the parent node by determining whether total cost to move to the current node is lower than the original total cost of the current node.

7. The method of claim 6 further comprising:
generating a list of costs for each grid cell in the data grid;
sorting the list of costs to determine a least cost grid cell; and
establishing a least cost traversal path as the reverse of path from the least cost grid cell to the start node based on each grid cell's parent node.

8. The method of claim 7 further comprising:
outputting the optimized path as a keyhole markup file (KML).

9. The method of claim 2 further comprising:
receiving the model data and obstacle data in the form extensible markup language (XML) files.

10. The method of claim 1 further comprising:
receiving the impact data as one of a set of integer values and a set of floating point values.

11. An apparatus for path optimization comprising:
a model import module that receives model data, obstacle data and impact data describing an environment and parses the model and obstacle data and constructing a multi-dimensional data grid from the model, obstacle and impact data; and
a path optimization module that calculates the cost of a path traversal from a start node to an end node based on the impact data.

12. The apparatus of claim 11 further comprising:
wherein the received model data is data modeling a three-dimensional (3D) environment, the obstacle data is data modeling obstacles in the 3D environment, and the impact data is data describing impact relating to moving to a particular location the 3D environment.

13. The apparatus of claim 12 further comprising:
augmenting, periodically, the model, obstacle and impact data over time as the 3D environment changes.

14. The apparatus of claim 13 further comprising:
performing the calculating of cost of path traversal with when the model, obstacle and impact data is augmented; and
providing a four dimensional optimized route based on the calculated cost of path traversal, wherein the optimized route is represented in three-dimensional space along a changing time dimension.

15. The apparatus of claim 14 wherein calculating the cost of path traversal further comprises:
calculating a total cost at a grid cell from a plurality of grid cells comprising the data grid by summing g(n), a sum of costs along a path to a current node from the start node, an impact cost from the impact data correlated to the current node, and h(n), a heuristic function estimating a least cost path remaining between the current node and the end node, wherein each node besides the start and end node have a parent node referencing another grid cell.

16. The apparatus of claim 15 further comprising:
performing the calculating a total cost from the start node to the end node, by:
selecting a grid cell as a parent cell and iterating over cells adjacent to the parent cell;
determine whether a current node, or grid cell, in the data grid is the start node or the parent cell;
calculating the cost of moving to each grid cell in the data grid, and moving that grid cell to a closed list if the cell is not the start node or the parent cell;
moving the current node to an open list if the cell is the start node or the parent cell;
determining a relative position between the current node and the parent cell;
determining a local cost of moving to the current node based on the determined relative position;
determining whether the current node is a better node than the parent node by determining whether total cost to move to the current node is lower than the original total cost of the current node.

17. The apparatus of claim 16 further comprising:
generating a list of costs for each grid cell in the data grid;
sorting the list of costs to determine a least cost grid cell; and
establishing a least cost traversal path as the reverse of path from the least cost grid cell to the start node based on each grid cell's parent node.

18. The apparatus of claim 17 further comprising:
outputting the optimized path as a keyhole markup file (KML).

19. The apparatus of claim 12 further comprising:
receiving the model data and obstacle data in the form extensible markup language (XML) files.

20. The apparatus of claim 11 further comprising:
receiving the impact data as one of a set of integer values and a set of floating point values.
